(19) United States
(12) Patent Application Publication
(10) Pub. No.: US 2023/0042946 A1
(43) Pub. Date: Feb. 9, 2023

(54) DEVICE, SYSTEM AND METHODS FOR ASSISTING A VEHICLE DRIVER WITH TRANSPORTING FOOD/DRINKS AND ASSOCIATED ITEMS

(71) Applicant: Jennifer Vermeer, Bozeman, MT (US)

(72) Inventor: Jennifer Vermeer, Bozeman, MT (US)

(21) Appl. No.: 17/861,867

(22) Filed: Jul. 11, 2022

Related U.S. Application Data
(60) Provisional application No. 63/231,076, filed on Aug. 9, 2021.

(51) Int. Cl. B60R 7/04; B60N 2/60; B60N 3/00; B60N 3/10; B60N 3/04

(52) U.S. Cl. CPC B60R 7/043; B60N 2/6027; B60N 2/6036; B60N 2/6063; B60N 3/002; B60N 3/044; B60N 3/103

(57) ABSTRACT

The system is for securely transporting food and associated items within a passenger compartment of a vehicle. The system includes a seat cover to be installed on a seat within the passenger compartment of the vehicle. A seat platform is carried by the seat bottom portion, and includes a non-slip upper surface segment positioned over a leveling support segment configured to sit atop a seat bottom of the seat. The leveling support segment includes a lower conformable compartment configured to conformably interface with the seat bottom and level the non-slip upper surface segment there above. The non-slip upper surface segment is configured to hold food containers and prevent sliding thereof. A plurality of holders are carried by the seat back portion of the seat cover and configured to hold the associated items. A drink holder may be coupled to a front of the seat platform and configured to securely hold a plurality of drinks.

### RELATED APPLICATION(S)

This application claims priority to provisional patent application U.S. Serial No., 63/231076 filed Aug. 9, 2021. The priority patent applications are herein incorporated by reference in their entirety.

### FIELD OF THE INVENTION

The present invention relates to the transporting of food/drinks for delivery, and more particularly to devices, systems and methods for holding food/drinks within the passenger compartment of a vehicle.

### BACKGROUND

Transporting food and drinks for delivery via a passenger vehicle is gaining popularity, especially in the gig economy. Various approaches have been developed to hold food bags and drinks within the passenger compartment.

Various problems with the prior art include the use of hard materials that will damage the seat and are not able to accommodate food delivery hot-bags. They also do not protect the seat and floor area from potential spills and do not have any guards to protect the bags of food from moving forward during acceleration/deceleration and turns.

US 2012/0006871 to Strohecker is directed to a device for holding food items while being transported in a motor vehicle having a seat with a seat belt. The device comprises a base member. A non-slip tray is positioned upon the base member. A mechanism is for enabling angle adjustment of the non-slip tray on the base member, so as to keep the food items placed upon the non-slip tray in a level position. The mechanism can be manual or automatic. Another mechanism is for securing the base member in a stationary manner on the seat of the motor vehicle with the seat belt.

U.S. 2008/0067205 to Semendoff teaches an article securing device for carrying articles in a vehicle on a vehicle seat includes an adjustable support plate, a first lip extending outwardly from the top surface of the support plate at the front edge thereof, and an adjustable leg extending outwardly from the bottom surface of the support plate at the rear edge thereof.

U.S. 2008/0134945 to Willey teaches an assembly for supporting at least one item while in transit within a vehicle having cushioned passenger seating. The assembly used during transit within a vehicle, has: a platform (for supporting the item) that has an aperture for receiving at least one primary support-post therethrough, and a plurality of recesses; an anchor for releasably securing the assembly between cushion structures within the vehicle is used (e.g., such that it can be wedged into the spacing between back support cushion and seat cushion).

U.S. 2008/0223913 to Nadeau teaches a wedge-shaped support caddy device suitably adapted to be placed on an automobile seat to provide a level surface on which to place objects, while also providing a container for smaller objects.

GB 2223466A to Mattingly is directed to a travel organizer for carrying personal items for use in a vehicle has a shaped base to facilitate stable location on a front seat of a vehicle. The organizer in one embodiment comprises a plastic molded lower shell which supports on its peripheral edge a plastics molded raised upper shell 44 in which pockets/cavities are formed, the two shells being hinged at to permit access to articles stored in the space between the two shells.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to devices, systems and methods for securely and reliably holding food/drinks within the passenger compartment of a vehicle.

This and other objects, advantages and features in accordance with the present invention may be provided by a system for securely transporting food and associated items within a passenger compartment of a vehicle. The system includes a seat cover configured to be installed on a seat within the passenger compartment of the vehicle, the seat cover including a seat back portion and a seat bottom portion. A seat platform is carried by the seat bottom portion, and includes a non-slip upper surface segment positioned over a leveling support segment configured to sit atop a seat bottom of the seat. The leveling support segment comprises a lower conformable compartment configured to conformably interface with the seat bottom and level the non-slip upper surface segment there above. The non-slip upper surface segment is configured to hold food containers and prevent sliding thereof. A plurality of holders are carried by the seat back portion of the seat cover and configured to hold the associated items. A drink holder is coupled to a front of the seat platform and configured to securely hold a plurality of drinks.

Additionally, and/or alternatively, the seat cover comprises a stretchable water-resistant material configured to cover a front and sides of a seat back and the seat bottom of the seat.

Additionally, and/or alternatively, the seat cover comprises a securing feature configured to secure the seat cover on the seat.

Additionally, and/or alternatively, the securing feature of the seat cover may be weighted pockets, straps, clips, fasteners, hook-and-loop fasteners, and/or elastic cords.

Additionally, and/or alternatively, the seat platform includes perimeter walls configured to prevent food containers from the food containers from falling during operation of the vehicle.

Additionally, and/or alternatively, a v-shaped tray may be coupled to the leveling support segment at a side thereof and configured to be positioned in a space between the seat and a center console of the vehicle.

Additionally, and/or alternatively, the drink holder comprises a detachable drink holder.

Additionally, and/or alternatively, a deployable floor cover may be coupled to the front of the seat platform and configured to be deployed to cover a floor area in front of the seat. The deployable floor cover may include a food container support segment configured to hold additional food containers and prevent sliding thereof.

Additionally, and/or alternatively, the lower conformable compartment of the leveling support segment is filled with at least one of a gel, beads, foam and pellets configured to be adjustably compliant and conformably interface with the seat bottom.

Another embodiment is directed to a system for securely transporting food and associated items within a passenger compartment of a vehicle. The system includes a seat cover configured to be installed on a seat within the passenger compartment of the vehicle, the seat cover including a seat back portion and a seat bottom portion. A seat platform is carried by the seat bottom portion, and includes a non-slip upper surface segment positioned over a leveling support segment configured to sit atop a seat bottom of the seat. The leveling support segment is configured to conformably interface with the seat bottom and level the non-slip upper surface segment there above. The non-slip upper surface segment is configured to hold food containers and prevent sliding thereof. A plurality of pockets are carried by the seat back portion of the seat cover and configured to hold the associated items.

Additionally, and/or alternatively, the seat cover comprises a stretchable water-resistant material configured to cover a front and sides of a seat back and the seat bottom of the seat.

Additionally, and/or alternatively, the seat cover comprises a securing feature configured to secure the seat cover on the seat.

Additionally, and/or alternatively, the securing feature of the seat cover comprises at least one of weighted pockets, straps, clips, fasteners, hook-and-loop fasteners, and elastic cords.

Additionally, and/or alternatively, the seat platform comprises perimeter walls configured to prevent food containers from the food containers from falling during operation of the vehicle.

Additionally, and/or alternatively, a v-shaped tray may be coupled to the leveling support segment at a side thereof and configured to be positioned in a space between the seat and a center console of the vehicle.

Additionally, and/or alternatively, a detachable drink holder may be coupled to a front of the seat platform and configured to securely hold a plurality of drinks.

Additionally, and/or alternatively, a deployable floor cover may be coupled to the front of the seat platform and configured to be deployed to cover a floor area in front of the seat. The deployable floor cover may include a food container support segment configured to hold additional food containers and prevent sliding thereof.

Additionally, and/or alternatively, a lower conformable compartment of the leveling support segment is filled with at least one of a gel, beads, foam and pellets configured to be adjustably compliant and conformably interface with the seat bottom.

Thus, the embodiments provide a system that installs within the passenger seat compartment of a vehicle and includes a passenger seat protector, made of a soft material, with a platform having a nonslip surface and that levels up the passenger seat so the contents of food containers/bags and drinks are supported and do not spill. The system also includes various pockets and holders carried on the seat back to organize items such as receipts, flashlights, straws and other items that might be needed during food delivery so that they are easily accessible. The system may include a detachable drink holder positioned adjacent the front of the passenger seat bottom, e.g. that holds four or more drinks. An extendable or roll out floor protector may also be included to extend out from the platform into the floor space in front of the seat so that additional food and drinks may be held securely. The system may also have protectors around the platform to keep food from sliding forward or backwards during stops, turns or acceleration. The system is preferably a single unit so it may be easily removed and stored, e.g., so passengers can ride in the passenger seat after removal.

### BRIEF DESCRIPTION OF THE DRAWINGS

Some embodiments of the present invention are illustrated as an example and are not limited by the figures of the accompanying drawings, in which like references may indicate similar elements.

FIG. 1 is a side view of an embodiment of a system for assisting a vehicle driver with transporting food/drinks and associated items in accordance with features of the present invention. FIG. 1 shows the system 10 installed on a passenger seat within a passenger compartment of a vehicle.

FIG. 2 is a perspective view of the system of FIG. 1.

FIG. 3 is a perspective view of another embodiment of the system.

FIG. 4 is a back view of the system of FIG. 1.

FIG. 5 is a side view of another embodiment of the system including features within the floor area of the passenger seat.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Before describing the present disclosure in detail, it is to be understood that this disclosure is not limited to parameters of the particularly exemplified systems, methods, apparatus, products, processes, and/or kits, which may, of course, vary. It is also to be understood that the terminology used herein is only for the purpose of describing particular embodiments of the present disclosure, and is not necessarily intended to limit the scope of the disclosure in any particular manner. Thus, while the present disclosure will be described in detail with reference to specific embodiments, features, aspects, configurations, etc., the descriptions are illustrative and are not to be construed as limiting the scope of the claimed invention. Various modifications can be made to the illustrated embodiments, features, aspects, configurations, etc. without departing from the spirit and scope of the invention as defined by the claims. Thus, while various aspects and embodiments have been disclosed herein, other aspects and embodiments are contemplated.

Unless defined otherwise, all technical and scientific terms used herein have the same meaning as commonly understood by one of ordinary skill in the art to which the present disclosure pertains. While a number of methods and materials similar or equivalent to those described herein can be used in the practice of the present disclosure, only certain exemplary materials and methods are described herein.

Various aspects of the present disclosure, including devices, systems, methods, etc., may be illustrated with reference to one or more exemplary embodiments or implementations. As used herein, the terms “embodiment,” “alternative embodiment” and/or “exemplary implementation” means “serving as an example, instance, or illustration,” and should not necessarily be construed as preferred or advantageous over other embodiments or implementations disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

It will be noted that, as used in this specification and the appended claims, the singular forms “a,” “an” and “the” include plural referents unless the content clearly dictates otherwise. Thus, for example, reference to a “sensor” includes one, two, or more sensors.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” variants thereof (e.g., “includes,” “has,” and “involves,” “contains,” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively.

Various aspects of the present disclosure can be illustrated by describing components that are coupled, attached, connected, and/or joined together. As used herein, the terms “coupled”, “attached”, “connected,” and/or “joined” are used to indicate either a direct connection between two components or, where appropriate, an indirect connection to one another through intervening or intermediate components. In contrast, when a component is referred to as being “directly coupled”, “directly attached”, “directly connected,” and/or “directly joined” to another component, no intervening elements are present or contemplated. Thus, as used herein, the terms “connection,” “connected,” and the like do not necessarily imply direct contact between the two or more elements. In addition, components that are coupled, attached, connected, and/or joined together are not necessarily (reversibly or permanently) secured to one another. For instance, coupling, attaching, connecting, and/or joining can comprise placing, positioning, and/or disposing the components together or otherwise adjacent in some implementations.

As used herein, directional and/or arbitrary terms, such as “top,” “bottom,” “front,” “back,” “left,” “right,” “up,” “down,” “upper,” “lower,” “inner,” “outer,” “internal,” “external,” “interior,” “exterior,” “proximal,” “distal” and the like can be used solely to indicate relative directions and/or orientations and may not otherwise be intended to limit the scope of the disclosure, including the specification, invention, and/or claims.

Where possible, like numbering of elements have been used in various figures. In addition, similar elements and/or elements having similar functions may be designated by similar numbering (e.g., element “10” and element “210.”) Furthermore, alternative configurations of a particular element may each include separate letters appended to the element number. Accordingly, an appended letter can be used to designate an alternative design, structure, function, implementation, and/or embodiment of an element or feature without an appended letter. Similarly, multiple instances of an element and or sub-elements of a parent element may each include separate letters appended to the element number. In each case, the element label may be used without an appended letter to generally refer to instances of the element or any one of the alternative elements. Element labels including an appended letter can be used to refer to a specific instance of the element or to distinguish or draw attention to multiple uses of the element. However, element labels including an appended letter are not meant to be limited to the specific and/or particular embodiment(s) in which they are illustrated. In other words, reference to a specific feature in relation to one embodiment should not be construed as being limited to applications only within said embodiment.

It will also be appreciated that where a range of values (e.g., less than, greater than, at least, and/or up to a certain value, and/or between two recited values) is disclosed or recited, any specific value or range of values falling within the disclosed range of values is likewise disclosed and contemplated herein.

It is also noted that systems, methods, apparatus, devices, products, processes, compositions, and/or kits, etc., according to certain embodiments of the present invention may include, incorporate, or otherwise comprise properties, features, aspects, steps, components, members, and/or elements described in other embodiments disclosed and/or described herein. Thus, reference to a specific feature, aspect, steps, component, member, element, etc. in relation to one embodiment should not be construed as being limited to applications only within said embodiment. In addition, reference to a specific benefit, advantage, problem, solution, method of use, etc. in relation to one embodiment should not be construed as being limited to applications only within the embodiment.

The headings used herein are for organizational purposes only and are not meant to be used to limit the scope of the description or the claims. To facilitate understanding, like reference numerals have been used, where possible, to designate like elements common to the figures.

An embodiment of the invention, as shown and described by the various figures and accompanying text, provides devices, systems and methods for holding food/drinks within the passenger compartment of a vehicle.

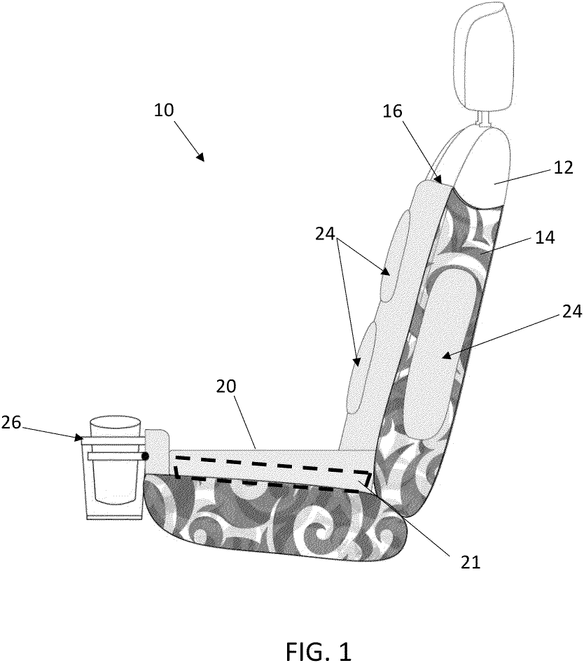

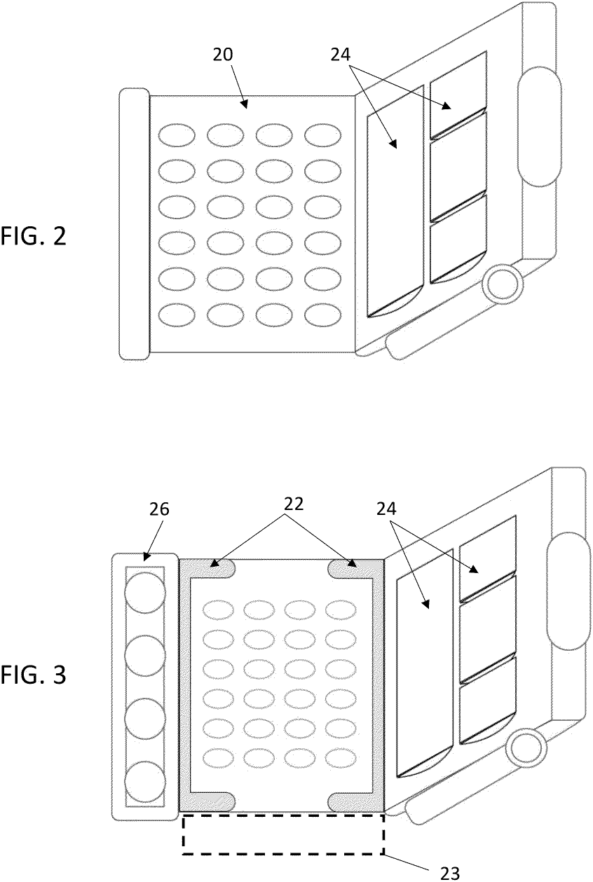

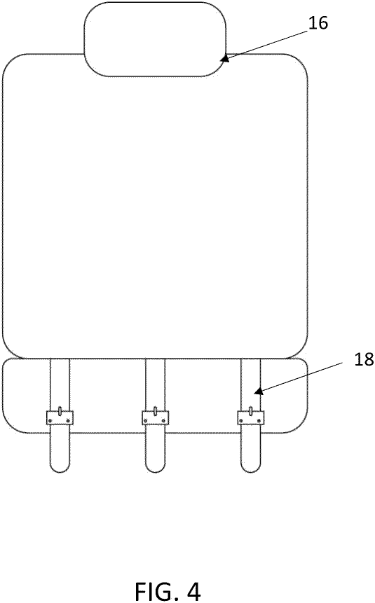

FIGS. 1-4 illustrate an embodiment of a system 10 for assisting a vehicle driver with transporting food/drinks and associated items in accordance with features of the present invention. FIG. 1 is a side view of the system 10 installed on a passenger seat 12, e.g., within a passenger compartment of a vehicle. FIG. 2 is a perspective view of the system 10, FIG. 3 is a perspective view of the system 10 with additional features, and FIG. 4 is a back view of the system 10.

The system 10 includes a cover 14 that may slip over, or otherwise be installed on, the seat 12 including the seat back and seat bottom. The material of the cover 14 may be flexible or stretchable, water resistant or water proof, and easy to clean. The cover 14 preferably covers the front and sides of the seat back as well as the front and sides of the seat bottom. As such, the sides of the cover 14 may be weighted or include other mechanisms to assist with keeping the cover in place. As illustrated in FIG. 4, for example, the cover 14 may include an opening or slot 16 for the headrest, and may also include straps 18 that extend between the seat back and seat bottom for securing the cover in place, for example, with clips or other fasteners such as hook-and-loop fasteners, adhesives, bungee cords, etc.

The cover 14 includes a platform 20 having a hard, rigid, and/or stiff non-slip surface positioned over a leveling support 21 that sits atop the seat bottom and provides a level non-slip surface to hold food containers and bags. The platform 20 may be sized to accommodate at least two larger food bags, for example. The non-slip surface may be rubber, for example, or any other surface material that provides appropriate adhesion to prevent slipping or sliding of food containers and bags.

The leveling support 21 may be or include a lower conformable compartment filled with gel, beads and/or pellets such as PVC, expanded polystyrene, or expanded polypropylene, for example, or any other material that provides the functionality of leveling the surface adjacent the seat bottom for holding food containers and bags in a secure and upright position. The leveling support 21 material is preferably configured to be adjustably compliant and conformably interface with the seat bottom.

As shown in FIG. 3, for example, portions of the perimeter of the platform 20 may include walls 22, or protectors, formed of a hard foam or rubber (or other insulation padding), for example, and may preferably be water resistant, waterproof and/or easy to clean. The walls 22 may be positioned at various areas of the platform 20 such as the front and back, and portions of the sides, for example, to prevent food containers and bags from sliding, rolling, falling and/or spilling during operation of the vehicle. The wall 22 at the front of the platform 20 may be higher than walls at the back and sides.

A tray 23 (e.g. v-shaped tray) may be coupled to the leveling support segment at a side thereof and configured to be positioned in a space between the seat and a center console of the vehicle. This tray 23 will provide storage for items needed by a delivery driver. Portions of the cover 14 that are positioned on the seat back and sides thereof, may include various pockets 24 or holders to store, hold and/or organize various items such as receipts, flashlights, straws and other items that might be needed during food delivery so that they are easily accessible by the delivery driver.

A drink holder 26 may be provided adjacent the wall 22 at the front of the platform 20. The drink holder 26 may hold at least four large drinks (e.g., as shown in FIG. 3) and may be detachable from the cover 14.

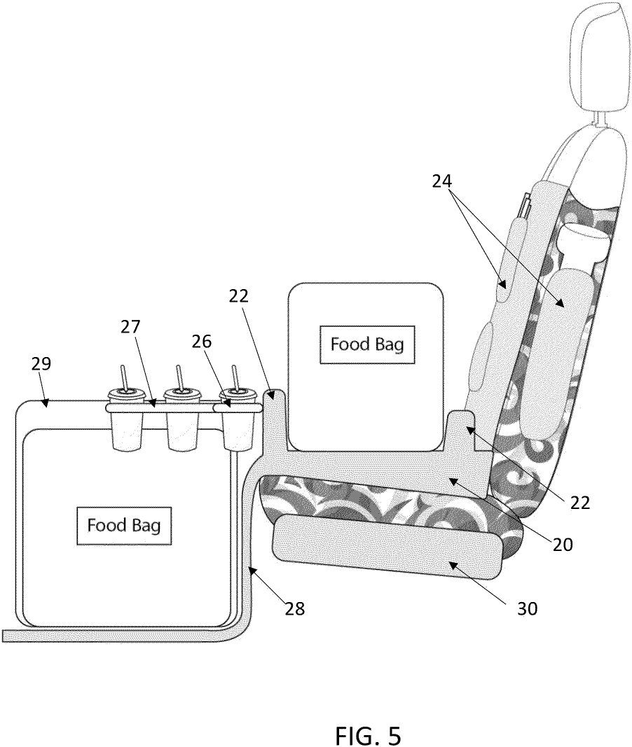

As shown in another embodiment illustrated in FIG. 5, a floor protector 28 may be attached at the front of the platform 20 and may be deployed or rolled out to cover the floor area in front of the passenger seat. The floor protector 28 may include a support area or box 29 (e.g., insulated box) to accommodate additional food containers or bags, and the top thereof may accommodate a flat container (e.g., a pizza box), for example. Furthermore, as illustrated, additional drink holders 27 may be positioned at a side of the box 29. Weighted pockets 30 may be included adjacent a bottom of the cover 14 to assist in keeping the cover in place.

Various problems may be addressed by the invention including: the incline of the passenger seat bottom (e.g., 3-5 degrees) and that causes food containers to spill and mix and damage the seat; spills and damage to the floor area; damage to the seats by hard containers that can wear on the seat and also cause holes in the seat; numerous food delivery related items, needed by delivery drivers, rolling around on the passenger seat and falling on the floor or in between the seat and vehicle center console without being organized or easily accessible; and the sliding around of food containers during driving.

A purpose of this invention is to organize and protect the passenger seat and floor from spills and to hold food delivery hot-bags and drinks in place and to level the passenger seat bottom to prevent spills from happening. This invention includes a passenger seat leveler platform that is made of soft material that doesn't damage the seat and that has guards around the platform to prevent containers from moving during driving. This invention preferably provides full protection of the passenger seat and floor area from potential spills. This invention preferably accommodates various standard food delivery hot-bags and drink cups.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced items.

1. A system for securely transporting food and associated items within a passenger compartment of a vehicle, the system comprising:
a seat cover configured to be installed on a seat within the passenger compartment of the vehicle, the seat cover including a seat back portion and a seat bottom portion;
a seat platform carried by the seat bottom portion, and including a non-slip upper surface segment positioned over a leveling support segment configured to sit atop a seat bottom of the seat;
the leveling support segment comprises a lower conformable compartment configured to conformably interface with the seat bottom and level the non-slip upper surface segment there above;
the non-slip upper surface segment is configured to hold food containers and prevent sliding thereof;
a plurality of holders carried by the seat back portion of the seat cover and configured to hold the associated items; and
a drink holder coupled to a front of the seat platform and configured to securely hold a plurality of drinks.

2. The system according to claim 1, wherein the seat cover comprises a water-resistant material configured to cover a front and sides of a seat back and the seat bottom of the seat.

3. The system according to claim 2, wherein the seat cover comprises a securing feature configured to secure the seat cover on the seat.

4. The system according to claim 3, wherein the securing feature of the seat cover comprises at least one of weighted pockets, straps, clips, fasteners, hook-and-loop fasteners, and elastic cords.

5. The system according to claim 1, wherein the seat platform comprises perimeter walls configured to prevent the food containers from falling during operation of the vehicle.

6. The system according to claim 1, further comprising a v-shaped tray coupled to the leveling support segment at a side thereof and configured to be positioned in a space between the seat and a center console of the vehicle.

7. The system according to claim 1, wherein the drink holder comprises a detachable drink holder.

8. The system according to claim 1, further comprising a deployable floor cover coupled to the front of the seat platform and configured to be deployed to cover a floor area in front of the seat.

9. The system according to claim 1, wherein the deployable floor cover comprises a food container support segment configured to hold additional food containers and prevent sliding thereof.

10. The system according to claim 1, wherein the lower conformable compartment of the leveling support segment is filled with at least one of a gel, beads, foam and pellets configured to be adjustably compliant and conformably interface with the seat bottom.

11. A system for securely transporting food and associated items within a passenger compartment of a vehicle, the system comprising:
a seat cover configured to be installed on a seat within the passenger compartment of the vehicle, the seat cover including a seat back portion and a seat bottom portion;
a seat platform carried by the seat bottom portion, and including a non-slip upper surface segment positioned over a leveling support segment configured to sit atop a seat bottom of the seat;
the leveling support segment configured to conformably interface with the seat bottom and level the non-slip upper surface segment there above;
the non-slip upper surface segment is configured to hold food containers and prevent sliding thereof; and
a plurality of pockets carried by the seat back portion of the seat cover and configured to hold the associated items.

12. The system according to claim 11, wherein the seat cover comprises a water-resistant material configured to cover a front and sides of a seat back and the seat bottom of the seat.

13. The system according to claim 12, wherein the seat cover comprises a securing feature configured to secure the seat cover on the seat.

14. The system according to claim 13, wherein the securing feature of the seat cover comprises at least one of weighted pockets, straps, clips, fasteners, hook-and-loop fasteners, and elastic cords.

15. The system according to claim 11, wherein the seat platform comprises perimeter walls configured to prevent the food containers from falling during operation of the vehicle.

16. The system according to claim 11, further comprising a v-shaped tray coupled to the leveling support segment at a side thereof and configured to be positioned in a space between the seat and a center console of the vehicle.

17. The system according to claim 11, further comprising a detachable drink holder coupled to a front of the seat platform and configured to securely hold a plurality of drinks.

18. The system according to claim 11, further comprising a deployable floor cover coupled to the front of the seat platform and configured to be deployed to cover a floor area in front of the seat.

19. The system according to claim 11, wherein the deployable floor cover comprises a food container support segment configured to hold additional food containers and prevent sliding thereof.

20. The system according to claim 11, further comprising a lower conformable compartment of the leveling support segment that is filled with at least one of a gel, beads, foam and pellets configured to be adjustably compliant and conformably interface with the seat bottom.
